(19) United States
(12) Patent Application Publication
(10) Pub. No.: US 2019/0287182 A1
(43) Pub. Date: Sep. 19, 2019

(54) Transaction Compliance Scoring System

(71) Applicant: American Express Travel Related Services Company, Inc., New York, NY (US)

(72) Inventors: Bobby Chetal, Gurgaon (IN); Iwao Fusillo, Merrick, NY (US); Tushar Kant Gaur, Ghaziabad (IN); Nilesh Anil Ghate, Phoenix, AZ (US); Anshul Jain, Gurgaon (IN); Vishal Jain, Gurgaon (IN); Abhishek Kachhara, Phoenix, AZ (US); Sanjay Madaan, Phoenix, AZ (US); Preetika Madan, New Delhi (IN); Shriram Nalwade, Phoenix, AZ (US); Esha Paul, Delhi (IN); Harsimaran Singh, Gurgaon (IN)

(73) Assignee: American Express Travel Related Services Company, Inc., New York, NY (US)

(21) Appl. No.: 15/981,417

(22) Filed: May 16, 2018

(30) Foreign Application Priority Data
Mar. 14, 2018 (IN) 201811009339

(51) Int. Cl. G06Q 40/00; G06Q 10/06

(52) U.S. Cl. CPC G06Q 40/12; G06Q 10/06398

(57) ABSTRACT

The system may be configured to perform operations including receiving a transaction history for a consumer having transaction information associated with a plurality of transactions; detecting within the transaction information for each transaction a characteristic, resulting in a plurality of characteristics; calculating a respective value associated with each characteristic, wherein the respective value is at least one of a number or percentage of transactions having the characteristic; assigning a respective weight to each characteristic, producing an assigned respective weight for each characteristic; applying the assigned respective weight to the respective value associated with each characteristic to produce a respective weighted value for each characteristic; combining the respective weighted values of the plurality of characteristics; and/or producing a compliance score in response to the combining the respective weight values.

### CROSS REFERENCE TO RELATED APPLICATIONS

This application claims priority to and the benefit of Indian Patent Application No. 201811009339, filed on Mar. 14, 2018 and entitled “TRANSACTION COMPLIANCE SCORING SYSTEM,” which is incorporated by reference herein in its entirety for all purposes.

### FIELD

The present disclosure generally relates to evaluating or scoring transactions to detect compliance with an entity's spending rules or spending policy.

### BACKGROUND

Companies often have spending policies or rules dictating to employees what types of transactions they may conduct with company funds or for which they may seek reimbursement (e.g., for travel and entertainment). The types of transactions allowed may be from a certain merchant, from a certain merchant type (e.g., a restaurant, movie theater, grocery store, etc.), for a certain amount (e.g., a daily dollar limit, meal limit, etc.), at a certain time of day, or the like. Employees are expected to follow the rules of the spending policy, but some employees do not and cause financial loss to the company.

However, it may be difficult to detect employees misusing or failing to comply with the spending policy, and to determine the amount of loss or how often such noncompliance occurs. Additionally, it may be difficult to predict which employees may be more of a risk to engage in noncompliant transactions, where such a prediction and monitoring of a high risk employee may be a useful preventative measure.

### SUMMARY

A system, method, and article of manufacture (collectively, “the system”) are disclosed relating to a transaction compliance scoring system. In various embodiments, the system may be configured to perform operations including receiving, by a processor, a transaction history for a consumer having transaction information associated with a plurality of transactions; detecting, by the processor, within the transaction information for each transaction of the plurality of transactions a characteristic, resulting in a plurality of characteristics; calculating, by the processor, a value associated with each characteristic of the plurality of characteristics, wherein the respective value is at least one of a number or percentage of transactions having the characteristic; assigning, by the processor, a respective weight to each characteristic of the plurality of characteristics, producing an assigned respective weight for each characteristic; applying, by the processor, the assigned respective weight to the respective value associated with each characteristic to produce a respective weighted value for each characteristic of the plurality of characteristics; combining, by the processor, the respective weighted values of the plurality of characteristics; and/or producing, by the processor, a compliance score in response to the combining the respective weighted values. In various embodiments, the operations may further comprise determining, by the processor, whether the compliance score is above a compliance score threshold.

In various embodiments, the characteristic may be a delinquent behavioral characteristic, which may be at least one of a returned check, a late payment charge, or a late credit payment, and wherein the compliance score is a delinquent risk score. In various embodiments, the characteristic may be a noncompliance characteristic, which may be at least one of a transaction from an unauthorized or suspicious merchant, for a personal expense, in a disallowed geographic location, during late-night hours, for a retail purchase, involving a cash withdrawal, or involving an expensed refund, wherein the value is a noncompliance characteristic value, wherein the weighted value is a noncompliance characteristic weighted value, and/or wherein the compliance score is a consumer-level noncompliance score. In various embodiments, the operations may further comprise combining, by the processor, the respective noncompliance characteristic weighted values associated with a single transaction of the plurality of transactions; and producing, by the processor, a transaction-level noncompliance score in response to the combining the noncompliance characteristic weighted values associated with a single transaction of the plurality of transactions. In various embodiments, the operations may further comprise determining, by the processor, whether the consumer-level noncompliance score is above a consumer-level noncompliance score threshold, and/or determining, by the processor, whether the transaction-level noncompliance score is above a transaction-level noncompliance score threshold

In various embodiments, the operations may further comprise analyzing, by the processor, transaction information associated with a first transaction of the plurality of transactions for a critical noncompliance characteristic and a peripheral noncompliance characteristic; detecting, by the processor, at least one of the critical noncompliance characteristic or the peripheral noncompliance characteristic in the transaction information associated with the first transaction; flagging, by the processor, the first transaction with at least one of a critical flag in response to detecting a critical noncompliance characteristic, or a peripheral flag in response to detecting a peripheral noncompliance characteristic;

calculating, by the processor, at least one of a critical characteristic value associated with the at least one critical noncompliance characteristic or a peripheral characteristic value associated with the at least one peripheral noncompliance characteristic; assigning, by the processor, a critical weight to the critical noncompliance characteristic and a peripheral weight to the peripheral noncompliance characteristic; applying, by the processor, at least one of the critical weight to the critical characteristic value, or the peripheral weight to the peripheral characteristic value; producing, by the processor, a first transaction-level noncompliance score in response to the applying at least one of the critical weight to the critical characteristic value, or the peripheral weight to the peripheral characteristic value; and/or determining, by the processor, whether the transaction-level noncompliance score is above a transaction-level noncompliance score threshold. In various embodiments, the operations may further comprise analyzing, by the processor, second transaction information associated with a second transaction of the plurality of transactions for a second critical noncompliance characteristic and a second peripheral noncompliance characteristic; detecting, by the processor, at least one of the second critical noncompliance characteristic or the second peripheral noncompliance characteristic in the second transaction information associated with the second transaction; flagging, by the processor, the second transaction with at least one of a second critical flag in response to detecting the second critical noncompliance characteristic, or a second peripheral flag in response to detecting the second peripheral noncompliance characteristic; calculating, by the processor, at least one of a second critical characteristic value associated with the second critical noncompliance characteristic or a second peripheral characteristic value associated with the second peripheral noncompliance characteristic; applying, by the processor, at least one of the critical weight to the second critical noncompliance characteristic, or the peripheral weight to the second peripheral noncompliance characteristic; producing, by the processor, a second transaction-level noncompliance score in response to the applying at least one of the critical weight to the second critical noncompliance characteristic, or the peripheral weight to the second peripheral noncompliance characteristic; and/or determining, by the processor, whether the second transaction-level noncompliance score is above the transaction-level noncompliance score threshold. In various embodiments, the operations may further comprise combining, by the processor, the first transaction-level noncompliance score and the second transaction-level noncompliance score to produce a consumer-level noncompliance score; and/or determining, by the processor, whether the consumer-level noncompliance score is above a consumer-level noncompliance score threshold. In various embodiments, the operations may further comprise combining, by the processor, the consumer-level noncompliance score and the compliance score to produce an overall consumer compliance score; and/or determining, by the processor, whether the overall consumer compliance score is above an overall consumer score threshold.

In various embodiments, the operations may further comprise determining, by the processor, a first spending type of a first transaction of the plurality of transactions; detecting, by the processor, a parameter associated with the first spending type in the transaction information of the first transaction; determining, by the processor, a parameter value of the parameter; assigning, by the processor, a parameter weight to the parameter; applying, by the processor, the parameter weight to the parameter value; producing, by the processor, a parameter score based on the applying the parameter weight to the parameter value; producing, by the processor, a spending score based on the parameter score; and/or determining, by the processor, if the spending score is above a spending score threshold. In various embodiments, the spending type is at least one of air travel and the parameter is at least one of booking time, cost per mile, or airline; ground travel and the parameter is at least one of booking time, cost per trip, or travel company; hotel and the parameter is at least one of booking time, average rate, and duration; or food and beverage and the parameter is at least one of average daily spend or average meal rate.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 depicts an exemplary transaction compliance scoring system, in accordance with various embodiments;

FIG. 2 depicts an exemplary delinquent risk user interface provided by a compliance system, in accordance with various embodiments;

FIG. 3 depicts an exemplary noncompliance user interface provided by a compliance system, in accordance with various embodiments;

FIG. 4 depicts an exemplary wasteful spending user interface provided by a compliance system, in accordance with various embodiments;

FIG. 5 depicts an exemplary method for producing a risk score, in accordance with various embodiments; and

FIG. 6 depicts exemplary method for producing a noncompliance score, in accordance with various embodiments;

FIG. 7 depicts exemplary method for producing a spending score, in accordance with various embodiments; and

FIG. 8 depicts exemplary method for producing an overall compliance score, in accordance with various embodiments.

### DETAILED DESCRIPTION

The detailed description of various embodiments makes reference to the accompanying drawings, which show the exemplary embodiments by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

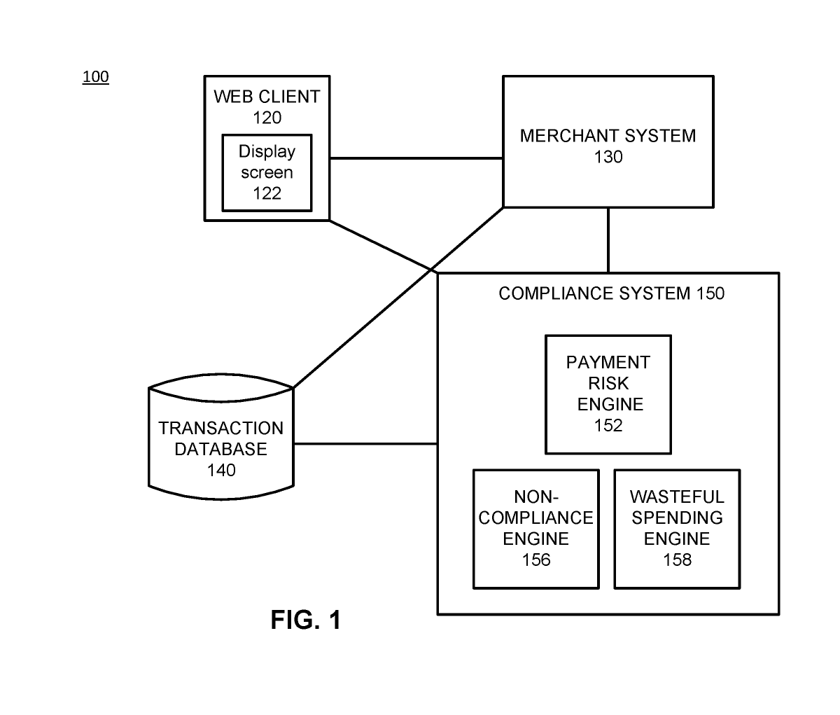

With reference to FIG. 1, an exemplary transaction compliance scoring system 100 is disclosed. In various embodiments, system 100 may comprise a web client 120, a merchant system 130, a transaction database 140, and/or a compliance system 150. All or any subset of components of system 100 may be in communication with one another via a network. System 100, or any components comprised therein, may be computer-based, and may comprise a processor, a tangible non-transitory computer-readable memory, and/or a network interface. Instructions stored on the tangible non-transitory memory may allow system 100 to perform various functions, as described herein.

In various embodiments, web client 120 may incorporate hardware and/or software components. For example, web client 120 may comprise a server appliance running a suitable server operating system (e.g., MICROSOFT INTERNET INFORMATION SERVICES or, “IIS”). Web client 120 may be any device that allows a user to communicate with a network (e.g., a personal computer, personal digital assistant (e.g., IPHONE®, BLACKBERRY®), cellular phone, kiosk, and/or the like). Web client 120 may be in communication with merchant system 130 and/or compliance system 150 via a network. Web client 120 may participate in any or all of the functions performed by merchant system 130 and/or compliance system 150 via the network.

Web client 120 includes any device (e.g., personal computer) which communicates via any network, such as those discussed herein. In various embodiments, web client 120 may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with merchant system 130 via network by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, handheld computers, personal digital assistants, set-top boxes, workstations, computer-servers, main frame computers, mini-computers, PC servers, pervasive computers, network sets of computers, personal computers, such as PADS®, IMACS®, and MACBOOKS®, kiosks, terminals, point of sale (POS) devices and/or terminals, televisions, or any other device capable of receiving data over a network. In various embodiments, the browser may be configured to display an electronic channel.

In various embodiments, a network may be an open network or a closed loop network. The open network may be a network that is accessible by various third parties. In this regard, the open network may be the internet, a typical transaction network, and/or the like. Network may also be a closed network. In this regard, network may be a closed loop network like the network operated by American Express. Moreover, the closed loop network may be configured with enhanced security and monitoring capability. For example, the closed network may be configured with tokenization, associated domain controls, and/or other enhanced security protocols. In this regard, network may be configured to monitor users on the network. In this regard, the closed loop network may be a secure network and may be an environment that can be monitored, having enhanced security features.

In various embodiments, merchant system 130 may be associated with a merchant, and may incorporate hardware and/or software components. For example, merchant system 130 may comprise a server appliance running a suitable server operating system (e.g., Microsoft Internet Information Services or, “IIS”). Merchant system 130 may be in communication with web client 120, transaction database 140, and/or compliance system 150. In various embodiments, merchant system 130 may comprise an online store, which consumers may access through the browser on web client 120 to purchase goods or services from the merchant.

In various embodiments, transaction database 140 may be associated with a transaction account issuer (an entity that issues transaction accounts to consumers, such as credit cards, bank accounts, etc.). Transaction database 140 may comprise hardware and/or software capable of storing data and/or analyzing information. Transaction database 140 may comprise a server appliance running a suitable server operating system (e.g., MICROSOFT INTERNET INFORMATION SERVICES or, “IIS”) and having database software (e.g., ORACLE) installed thereon. Transaction database 140 may be in electronic communication with merchant system 130 and/or compliance system 150. In various embodiments, transaction database 140 may comprise software and hardware configured to receive and store transaction information from transactions completed between at least two parties (e.g., merchants and consumers). Transaction information may include details and/or characteristics of the associated transaction(s), such as a transaction location, merchant, merchant type, item purchased, monetary amount, date, time, credit payment time/amount, etc. The consumers involved in the transactions may hold transaction accounts issued from the transaction account issuer that is associated with system 100 and/or compliance system 150.

In various embodiments, consumers (i.e., employees of companies) may engage in transactions with merchant system 130 (representing multiple merchants with which the consumer may transact). Transaction information associated with each transaction may be transmitted to transaction database 140 for storage. There may be a plurality of transactions and associated transaction information.

In various embodiments, compliance system 150 may comprise hardware and/or software capable of storing data and/or analyzing information. Compliance system 150 may comprise a server appliance running a suitable server operating system (e.g., MICROSOFT INTERNET INFORMATION SERVICES or, “IIS”) and having database software (e.g., ORACLE) installed thereon. Compliance system 150 may be in electronic communication with web client 120, merchant system 130, and/or transaction database 140. In various embodiments, compliance system 150 may comprise various engines to analyze transactions, and transaction information associated therewith, to determine whether a consumer that is utilizing a transaction instrument is complying with certain spending policy rules. Every company (i.e., employer) may have a spending policy which dictates appropriate financial and transactional behavior of the company's employees for, for example, reimbursable expenses, approved merchants, merchant types, spending amounts (e.g., a daily dollar limit, or meal limit, or trip limit), or the like. The spending policy for each company may be different, and/or comprise different levels of appropriate transactional behavior based on a company or employee's location, level (e.g., entry level vs. management level), authorization, etc. Therefore, a company may need to be able to select which, or the level of, transactional behaviors to be monitored, detected, analyzed, and/or reported by compliance system 150, and thus, customize the analysis and output of compliance system 150 and the engines therein to reflect the company's information needs.

In various embodiments, compliance system 150 may comprise a payment risk engine 152, a noncompliance engine 156, and/or a wasteful spending engine 158. Each engine may analyze a transaction(s) in a consumer's transaction history to determine a compliance score for the transaction and/or the consumer indicating whether the transaction and/or consumer is or has been compliant with company spending policies, or whether the consumer poses a risk of noncompliance. In various embodiments, one or more of the engines comprised in compliance system 150 may receive transaction information for a transaction in real time to analyze the transaction information and detect noncompliance. Thus, a company may identify potential noncompliance, and approve or reject a transaction in real time.

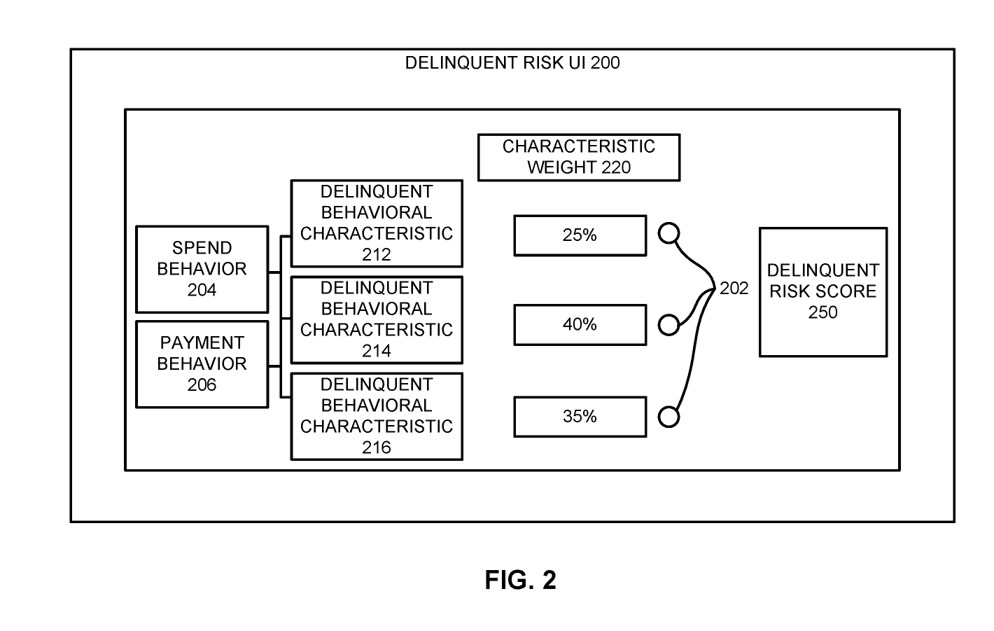

In various embodiments, with combined reference to FIGS. 1 and 2, payment risk engine 152 may be configured to determine the risk that a consumer will fall delinquent in her credit payments, and therefore expose the company to loss such as late payment fees, credit loss, unpaid balance, or the like. Delinquent risk user interface (UI) 200 may be displayed to a user of system 100 and/or compliance system 150 via payment risk engine 152 and/or compliance system 150 on a display screen 122 comprised in web client 120. In various embodiments, compliance system 150 may determine, and/or a company may input into compliance system 150 and/or payment risk engine 152, factors for which the company would like to analyze transaction information. That is, the selected factors may be indicators of risky or noncompliant transactional behavior.

Therefore, the company may determine that it would like to analyze transaction information for delinquent behavioral characteristics 212-216 (i.e., the factors). Payment risk engine 152 may analyze a consumer's (or multiple consumers’) spend behavior 204 and/or payment behavior 206 within the transaction information for delinquent behavioral characteristics. Delinquent behavioral characteristics 212-216 may comprise consumer behavioral characteristics of transactions indicating that a consumer may become delinquent in their credit payments, and therefore, expose the company (i.e., the consumer's employer) to financial loss. Payment risk engine 152 may search for transactions and/or consumers having or reflecting those delinquent behavioral characteristics 212-216. In various embodiments, delinquent behavioral characteristics 212-216 may be at least one of a returned check, a late payment charge, or a late credit payment (reflecting delinquency in payment behavior 206). For example, delinquent behavioral characteristics 212-216 may cause payment risk engine 152 to look for transactions or consumers (e.g., searching through the transaction history associated with a consumer profile(s) of the consumer) reflecting a returned check (indicating an overdraw on an account), late credit payments (e.g., failing to make minimum monthly payment), late payment fees, or the like. In various embodiments, delinquent behavioral characteristics 212-216 may be or reflect at least one of abnormal spending (e.g., larger monetary or transaction amounts than normal/average), a suspicious or unapproved merchant, or the like (reflecting delinquency in spend behavior 204). A company may elect any desired number of delinquent behavioral characteristics for which to analyze transaction information, and provide them to compliance system 150 and/or payment risk engine 152 for detection and analysis. Delinquent behavioral characteristics 212-216 may be displayed on delinquent UI 200.

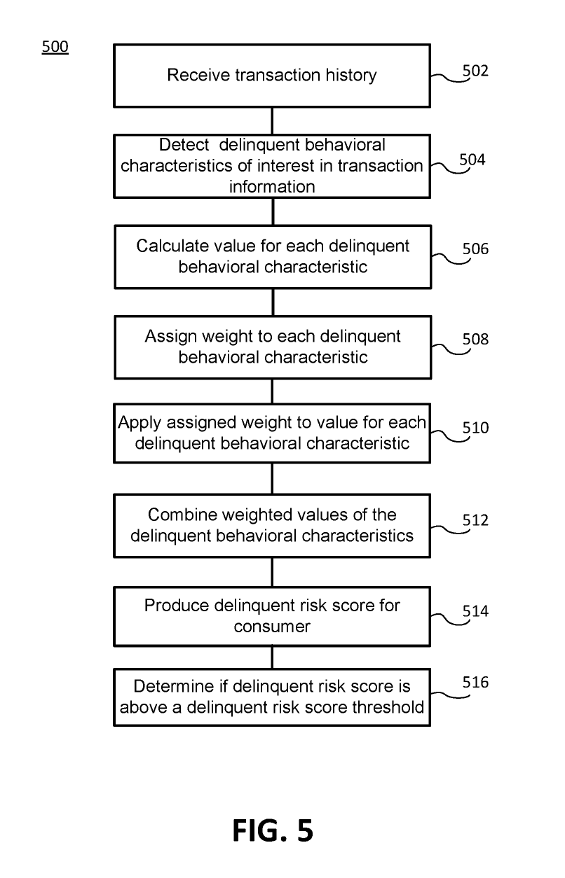

With additional reference to FIG. 5, which depicts a method 500 for producing a delinquent risk score, payment risk engine 152 may determine a delinquent risk score 250 for a respective consumer. Delinquent risk score 250 may indicate to compliance system 150 and/or the company the risk of delinquency posed by the associated consumer. By utilizing payment risk engine 152, a company may be able to determine the high risk employees, which may cause financial harm to the company, reach out to the employee to explain the company spending policy, and/or monitor the employees transactional behavior to make sure all transactions are policy-compliant (and deny noncompliant transactions). The user may indicate to payment risk engine 152 any time period during which transaction history may be evaluated to produce a delinquent risk score 250 (e.g., by entering a start date and/or time and an end date and/or time). In various embodiments, compliance system 150 and/or payment risk engine 152 may receive a subset or full transaction history (step 502) associated with a consumer from transaction database 140. The transaction history may comprise transaction information for a plurality of transactions to which the consumer was a party.

Payment risk engine 152 may analyze the transaction information for each transaction, and detect delinquent behavioral characteristics 212-216 of interest (step 504), as dictated and input by the company utilizing compliance system 150 (payment risk engine 152 may detect delinquent behavioral characteristics 212-216 within a broad variety of behavioral characteristics (some of which may not indicate potential delinquency), which indicate a consumer's risk of being delinquent with credit use and/or payment). Delinquent behavioral characteristics, indicating that a consumer may be at (high) risk of being delinquent, may be determined by compliance system 150 and/or payment risk engine 152 by comparing the behavioral characteristics of a consumer determined to be compliant with the behavioral characteristics of a consumer determined to be delinquent. That is, the transaction histories of a compliant consumer(s) and a delinquent consumer(s) may be compared (which may be an iterative process). The behavioral characteristics distinguishing a compliant consumer and a delinquent consumer may be identified as the delinquent behavioral characteristics (i.e., identifying which behavioral characteristics are reflected by delinquent consumers, but not reflected by compliant consumers). In various embodiments, delinquent behavioral characteristics 212-216, for which payment risk engine 152 searches and analyzes transaction information, may be determined by payment risk engine 152. Payment risk engine 152 may start analyzing transaction information associated with a consumer, detecting a large number (e.g., over 100) of delinquent behavioral characteristics, and determining a risk score based thereon (as described further herein). Payment risk engine 152, from the large number of delinquent behavioral characteristics, may determine which delinquent behavioral characteristics are most significant in determining delinquent risk score 250 (i.e., determining which delinquent behavioral characteristics, or the present/absence thereof, affect delinquent risk score 250 most). Therefore, payment risk engine 152 may analyze the transaction information for those significant delinquent behavioral characteristics (which may comprise a smaller number of delinquent behavioral characteristics, e.g., 5-15 delinquent behavioral characteristics).

In response to detecting delinquent behavioral characteristics 212-216 in the consumer's transaction information (each transaction may comprise more than one detected delinquent behavioral characteristic 212-216), payment risk engine 152 may categorize the transactions based on the detected delinquent behavioral characteristics 212-216. For example, payment risk engine 152 may separate the transactions into categories of delinquent behavioral characteristics 212-216: bounced check events, late payment fees, overdue balance events, abnormal spending, suspicious or unnaproved merchant, etc. A transaction may be categorized in multiple categories of delinquent behavioral characteristics 212-216. In various embodiments, payment risk engine 152 may calculate a value for each delinquent behavioral characteristic 212-216 (step 506). For example, payment risk engine 152 may count the number of transactions having (or the dollar amount reflecting) a certain delinquent behavioral characteristic (e.g., there are six transactions showing a returned check, three instances of late payment fees, or the like). As another example, payment risk engine 152 may calculate the percentage of transactions (or percentage of money involved) having a certain delinquent behavioral characteristic (e.g., seven percent of transactions in the consumer's transaction history show a returned check, or the like). The value for each delinquent behavioral characteristic 212-216 may be displayed on delinquent risk UI 200.

In various embodiments, a weight (such as characteristic weights 220 in FIG. 2) may be assigned to each delinquent behavioral characteristic 212-216 (step 508), such that when producing delinquent risk score 250, certain delinquent behavioral characteristics 212-216 may influence the resulting delinquent risk score 250 more than others. For example, one delinquent behavioral characteristic may be a stronger indicator of financial or transactional delinquency by a consumer, or a company may be more worried about one delinquent behavioral characteristic more than another. Therefore, the company and/or payment risk engine 152 may assign a higher characteristic weight 220 to such a delinquent behavioral characteristic. As shown in FIG. 2, first delinquent behavioral characteristic 212 is assigned a characteristic weight 220 of 25%, second delinquent behavioral characteristic 214 is assigned a characteristic weight 220 of 40%, and third delinquent behavioral characteristic 216 is assigned a characteristic weight 220 of 35%. Therefore, second delinquent behavioral characteristic 214 may be the best indicator of a consumer's financial or transactional delinquency, and/or the company using compliance system 150 may be most concerned with second delinquent behavioral characteristic 214. The company utilizing compliance system 150 may simply input each desired characteristic weight 220 into delinquent risk UI 200 next to the respective delinquent behavioral characteristic 212-216, and payment risk engine 152 will receive, implement, and display the same on delinquent risk UI 200. Additionally, the characteristic weights 220 may be revised or updated at any time to reflect changed needs of a company (i.e., the user of compliance system 150).

In various embodiments, though there may be numerous delinquent behavioral characteristics 212-216 which payment risk engine 152 may analyze to determine delinquent risk score 250 for a consumer, the user of payment risk engine 152 may select which delinquent behavioral characteristics 212-216 are to be taken into account in producing delinquent risk score 250. To do so, the user may select or deselect delinquent behavioral characteristics 212-216, for example, by selecting selectors 202. Payment risk engine 152 may receive such selections, and only utilize the selected delinquent behavioral characteristics 212-216 in producing delinquent risk score 250 for a consumer. In various embodiments, different delinquent behavioral characteristics 212-216 may be utilized to produce delinquent risk scores 250 for different consumers or groups of consumers.

In various embodiments, as part of producing delinquent risk score 250 for a consumer, the characteristic weight 220 assigned to each delinquent behavioral characteristic 212-216 may be applied to (e.g., multiplied by) the respective value calculated for the each delinquent behavioral characteristic 212-216 (step 510), producing a weighted value for each delinquent behavioral characteristic 212-216. The weighted values produced may be presented to the user on delinquent risk UI 200. Additionally, for each delinquent behavioral characteristic 212-216, there may be a weighted value threshold, to which payment risk engine 152 may compare the respective weighted value to determine if that weighted value for that delinquent behavioral characteristic indicates that the consumer is at-risk for delinquency at least for that delinquent behavioral characteristic. For example, if first delinquent behavioral characteristic 212 produces a weighted value of 12 (an arbitrarily chosen value for the sake of this example), but such a weighted value is above (or below) a weighted value threshold indicating the tolerable weighted value of first delinquent behavioral characteristic 212, payment risk engine 152 (or the user of compliance system 150) may determine that that consumer is, or is at-risk of being, delinquent. Therefore, any weighted value for one or more delinquent behavioral characteristics 212-216 may be delinquent risk score 250 desired by the user of compliance system 150. Similarly, any value for one or more delinquent behavioral characteristics 212-216 may be delinquent risk score 250, and compared with a value threshold to determine if a consumer is, or is at-risk of being, delinquent.

In various embodiments, delinquent risk score 250 may be determined from multiple delinquent behavioral characteristics 212-216. Therefore, payment risk engine 152 may combine the weighted values of delinquent behavioral characteristics 212-216 (step 512) (e.g., summing the delinquent behavioral characteristic weighted values), which may produce delinquent risk score 250 (step 514) for the consumer. In various embodiments, payment risk engine 152 may compare delinquent risk score 250 to a delinquent risk score threshold (which may be dictated and input by the company into payment risk engine 152 reflecting its tolerance for potential risk) to determine if delinquent risk score 250 is above (or below) the delinquent risk score threshold (step 516). If delinquent risk score 250 is above (or below) the delinquent risk score threshold, compliance system 150 and/or the user thereof may determine that the subject consumer associated with the analyzed transaction information is, or is at-risk of being, delinquent.

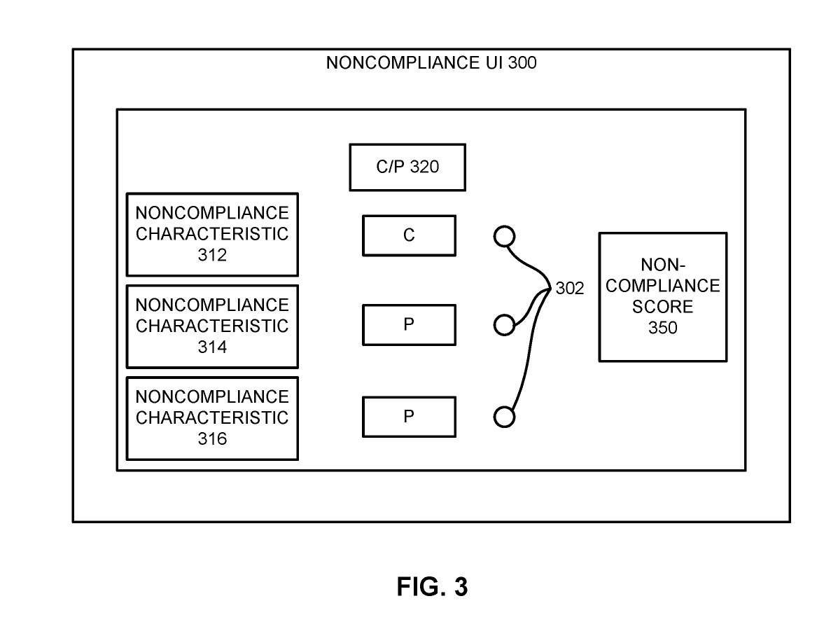

In various embodiments, with reference to FIGS. 1 and 3, noncompliance engine 156 may determine if a transaction(s) made by a consumer, and/or the consumer's transaction history, reflects transactions that are (non)compliant with the company's financial policies. Therefore, noncompliance engine 156 may produce an noncompliance score, either on the transaction level or the consumer level, which may indicate whether the consumer's transactions are compliant with company policies, or the level at which the consumer is complying (or not). Noncompliance UI 300 may be displayed to a user of system 100 and/or compliance system 150 via noncompliance engine 156 and/or compliance system 150 on a display screen 122 comprised in web client 120. In various embodiments, the noncompliance UI 300 may be a separate UI for viewing by the user than delinquent risk UI 200, discussed herein.

In various embodiments, the company (or other user) using compliance system 150 may determine and input into compliance system 150 and/or noncompliance engine 156 factors for which the company would like to analyze transaction information. That is, the selected factors may be indicators of noncompliance with the company's financial or transaction policies. Therefore, the company may determine that it would like to analyze transaction information for noncompliance characteristics 312-316 (i.e., the factors). Noncompliance characteristics 312-316 may comprise characteristics of transactions indicating that a transaction may be noncompliant with company policy, and/or that a consumer may be, or start or continue being, noncompliant with company policy. For example, noncompliance characteristics 312-316 may cause noncompliance engine 156 to look for transaction information or consumers (e.g., searching through the transaction history associated with a consumer profile(s) of the consumer) reflecting transactions, for example, from an unauthorized or suspicious merchant or merchant type (e.g., a retail store, casino, or the like), for a personal expense, in a disallowed geographic location (e.g., a transaction in a home city, and not on a business trip, or in a high-risk area), during late-night hours (e.g., occurring after midnight, or 2 A.M.), for a retail purchase, involving a cash withdrawal, involving an expensed refund (a transaction for which the consumer was reimbursed, but still expensed to the company), or the like. A company may elect any desired number of noncompliance characteristics for which to analyze transaction information and input them into noncompliance engine 156. Noncompliance characteristics 312-316 may be displayed on noncompliance UI 300. In various embodiments, the company may determine which noncompliance characteristics are critical (i.e., a significant indication that the consumer is being noncompliant with company policy, and may represent noncompliance characteristics which are more concerning or relevant to the company) and which noncompliance characteristics are peripheral (i.e., a borderline indication that the consumer is being noncompliant with company policy, but multiple such transaction may provide significant indication of noncompliance).

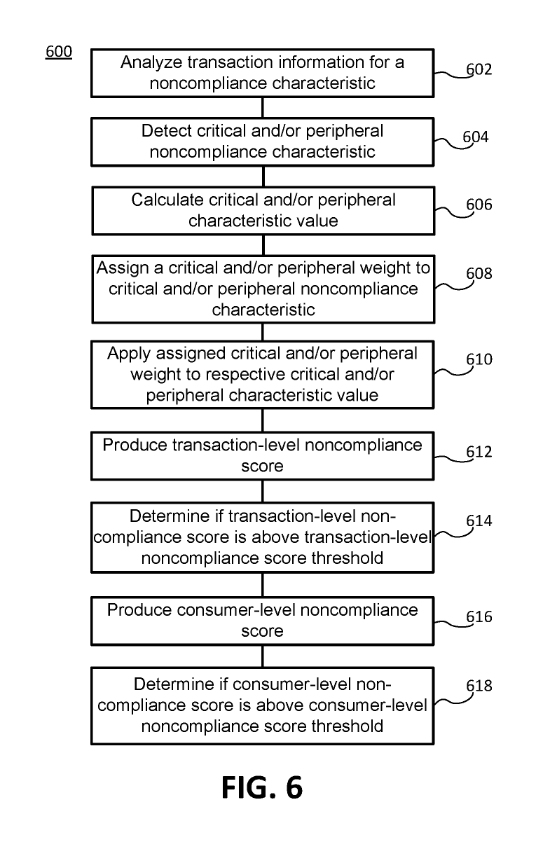

In various embodiments, with additional reference to FIG. 6, which depicts a method 600 for producing a noncompliance score, noncompliance engine 156 may determine a noncompliance score for a transaction(s) or a consumer. By utilizing noncompliance engine 156, a company may be able to determine employees with a history of, or at risk of, making transactions with company funds that are not compliant with company policy, and reach out to the employee to reprimand or warn of such transactional behavior, or monitor the employees transactional behavior to stifle such noncompliance. The user may indicate to noncompliance engine 156 any time period during which transaction history may be evaluated to produce a noncompliance score 350 (e.g., by entering a start date and/or time and an end date and/or time). Also, noncompliance engine 156 may offer reactive action, in which the company may analyze (e.g., in real time) a transaction as it is received by compliance system 150 and/or noncompliance engine 156, and approve or deny the transaction (or reimbursement thereof) based on the noncompliance score from noncompliance engine 156.

In various embodiments, compliance system 150 and/or noncompliance engine 156 may receive transaction information associated with a consumer (e.g., transaction information for one or more transactions) from transaction database 140. As discussed above, the transaction information for a transaction may be received in real time. Noncompliance engine 156 may analyze the transaction information for a noncompliance characteristic (step 602), and detect noncompliance characteristics of interest. That is, noncompliance engine 156 may detect a critical and/or peripheral noncompliance characteristic in the transaction information (step 604), and/or specific noncompliance characteristic types.

In response to detecting critical and/or peripheral noncompliance characteristic in the transaction information, (the transaction information for a transaction may comprise one or more critical and/or peripheral characteristics), noncompliance engine 156 may categorize the transactions and/or noncompliance characteristics based on the detected noncompliance characteristics. For example, noncompliance engine 156 may categorize the detected noncompliance characteristics into critical noncompliance characteristics and peripheral noncompliance characteristics, or by each noncompliance characteristic, and may indicate if each noncompliance characteristic is critical or peripheral. In various embodiments, noncompliance engine 156 may calculate a value for each noncompliance characteristic (i.e., calculate a value for each detected critical and/or peripheral noncompliance characteristic) (step 606). For example, noncompliance engine 156 may count the number of critical noncompliance characteristics and/or the number of peripheral noncompliance characteristics, or the monetary amount associated with the same (e.g., the transaction information reflects two critical noncompliance characteristics (the critical noncompliance characteristic value) and five peripheral noncompliance characteristics (the peripheral noncompliance characteristic value)). As another example, noncompliance engine 156 may calculate the percentage noncompliance characteristics (or percentage of total spending amount) being critical, peripheral, both, and/or neither (e.g., one percent of noncompliance characteristics are critical and eleven percent are peripheral, or 98 percent of the noncompliance characteristics are not critical or peripheral noncompliance characteristics). The value for each noncompliance characteristic may be displayed on noncompliance UI 300.

In various embodiments, a critical weight (such as characteristic weights 220 in FIG. 2) may be assigned to critical noncompliance characteristics and a peripheral weight may be assigned to peripheral noncompliance characteristics (step 608). The critical and peripheral weights may be displayed on noncompliance UI 300. Additionally, a number of peripheral noncompliance characteristics may be assigned as equivalent to one critical noncompliance characteristic. For example, a company may decide that five peripheral noncompliance characteristics is as significant for detecting noncompliance as one critical noncompliance characteristic. Noncompliance UI 300 may have a critical/peripheral indicator 320, wherein detected critical noncompliance characteristics are flagged with a “C” and peripheral noncompliance characteristics are flagged with a “P.” As shown in FIG. 3, first noncompliance characteristic is a critical noncompliance characteristic, and second noncompliance characteristic 314 and third noncompliance characteristic 316 are peripheral noncompliance characteristics. The company utilizing compliance system 150 may simply input each noncompliance characteristic to be considered or designated as critical or peripheral into noncompliance UI 300. Additionally, noncompliance characteristics may be re-designated as critical or peripheral, or (un)designated as a noncompliance characteristic of interest at any time to reflect changed needs of a company (i.e., the user of compliance system 150).

In various embodiments, though there may be numerous noncompliance characteristics which noncompliance engine 156 may analyze and detect as critical, peripheral, or neither to determine a noncompliance score for a transaction and/or consumer, the user of noncompliance engine 156 may select which noncompliance characteristics are to be taken into account in producing the noncompliance score. To do so, the user may select or deselect noncompliance characteristics 312-316, for example, by selecting selectors 302. Noncompliance engine 156 may receive such selections, and only utilize the selected noncompliance characteristics in producing the noncompliance score for a transaction and/or consumer. In various embodiments, different noncompliance characteristics may be utilized to produce noncompliance scores for different transactions or consumers, or groups of transactions or consumers.

In various embodiments, as part of producing the noncompliance score for a transaction, the critical weight may be applied to (e.g., multiplied by) the respective critical noncompliance characteristic value, and the peripheral weight may be applied to (e.g., multiplied by) the respective peripheral noncompliance characteristic value (step 610), producing a weighted critical noncompliance characteristic value and a weighted peripheral noncompliance characteristic value, respectively. The weighted critical and/or peripheral noncompliance characteristic value(s) for each noncompliance characteristic may be displayed on noncompliance UI 300. For example, the critical weight may be applied to the critical characteristic value (e.g., the number or percentage of critical noncompliance characteristics), and the peripheral weight may be applied to the peripheral characteristic value (e.g., the number or percentage of peripheral noncompliance characteristics). In various embodiments the peripheral weight may be adjusted by multiplying the peripheral weight by the fraction (1/(number of peripheral noncompliance characteristics equivalent to one critical noncompliance characteristic)), creating an adjusted peripheral weight. The adjusted peripheral weight may be applied to the peripheral characteristic value (e.g., the number or percentage of peripheral noncompliance characteristics). The critical and/or peripheral weight, and/or the equivalence number (number of peripheral noncompliance characteristics equal to one critical noncompliance characteristic) may be input into noncompliance engine 156 via noncompliance UI 300 by the user.

In various embodiments, the user of compliance system 150 may set a critical threshold, wherein if the critical characteristic value (i.e., number or percentage of critical noncompliance characteristics), or the weighted critical noncompliance characteristic value, exceeds the critical threshold, the transaction and/or consumer is deemed noncompliant. Likewise, the user of compliance system 150 may set a peripheral threshold, wherein if the peripheral characteristic value (i.e., number or percentage of peripheral noncompliance characteristics), or the weighted peripheral noncompliance characteristic value, exceeds the peripheral threshold, the transaction and/or consumer is deemed noncompliant.

In response to applying the critical weight and/or the peripheral weight to the critical and/or peripheral characteristic value, respectively, noncompliance engine 156 may produce a transaction-level noncompliance score (step 612) for a single transaction (e.g., noncompliance score 350), indicating whether the transaction is compliant with company policy. The transaction-level noncompliance score may be produced for a transaction having multiple detected critical and/or peripheral noncompliance characteristics, for example, by combining (e.g., summing or multiplying) the weighted critical noncompliance characteristic values and/or the weighted peripheral noncompliance characteristic values. The company may have selected, and input into noncompliance engine 156, a transaction-level noncompliance score threshold, above (or below) which, the company has decided will indicate that the transaction is noncompliant. Therefore, noncompliance engine 156 or the user may compare the transaction-level noncompliance score with the transaction-level noncompliance score threshold to determine whether the score is above (or below) the threshold (step 614). Based on that determination, noncompliance engine 156 or the user may determine if the subject transaction is compliant.

Steps 602-614 of method 600 may be repeated for any desired number of transactions.

For example step 602-614 may be repeated for transaction information associated with a second transaction to produce a second transaction-level noncompliance score. Subsequently, a consumer-level noncompliance score may be produced (step 616) by combining (e.g., summing or multiplying) the transaction-level noncompliance scores (e.g., the first and second transaction-level noncompliance scores). In various embodiments, the consumer-level noncompliance score may be produced by combining (e.g., summing) all the critical noncompliance characteristic values for all transactions associated with a consumer and/or all the peripheral noncompliance characteristic values for all transactions associated with a consumer. In response, the critical weight and/or peripheral weight may be applied to the total critical noncompliance characteristic value and the total peripheral noncompliance characteristic value, respectively, and the resulting weighted total critical noncompliance characteristic value and weighted total peripheral noncompliance characteristic value may be combined (e.g., summed or multiplied) to produce the consumer-level noncompliance score. In various embodiments, the consumer-level noncompliance score may be produced by combining (e.g., summing or multiplying) the weighted critical noncompliance characteristic values and/or the weighted peripheral noncompliance characteristic values for all transactions analyzed by noncompliance engine 156. The company may have selected a consumer-level noncompliance score threshold, above (or below) which, the company has decided will indicate that the consumer is noncompliant. Therefore, noncompliance engine 156 or the user may compare the consumer-level noncompliance score with the consumer-level noncompliance threshold to determine whether the score is above (or below) the threshold (step 618). Based on that determination, noncompliance engine 156 or the user may determine if the subject consumer is compliant. Any of the (weighted) values described herein may be displayed on noncompliance UI 300.

In various embodiments, noncompliance engine 156 may detect noncompliance characteristics of interest (similar to detecting delinquent behavioral characteristics in step 504, described herein) and categorize them by type (e.g., transactions from an unauthorized or suspicious merchant, for a personal expense, in a disallowed geographic location, during late-night hours, for a retail purchase, involving a cash withdrawal, involving an expensed refund, etc.). These noncompliance characteristics may be displayed on noncompliance UI 300 (e.g., noncompliance characteristics 312-316). Noncompliance characteristics, indicating that a consumer may be at (high) risk of being noncompliant with company policy, may be determined by compliance system 150 and/or noncompliance engine 156 by comparing the noncompliance characteristics of a consumer determined to be compliant with the noncompliance characteristics of a consumer determined to be noncompliant. The noncompliance characteristics distinguishing a compliant consumer and a noncompliant consumer may be identified as the noncompliance characteristics (i.e., identifying which noncompliance characteristics are reflected by noncompliant consumers, but not reflected by compliant consumers). A transaction may be categorized in multiple categories of noncompliance characteristics. Therefore, noncompliance score 350 may be based on the noncompliance characteristics without designating some noncompliance characteristics as critical and others as peripheral.

In various embodiments, noncompliance engine 156 may calculate (and display on noncompliance UI 300) a noncompliance characteristic value for each noncompliance characteristic (similar to calculating values for delinquent behavioral characteristics in step 506, described herein). For example, noncompliance engine 156 may count the number of transactions having (or the dollar amount reflecting) a certain noncompliance characteristic (e.g., there are eleven transactions with an unauthorized merchants, five expensed refunds, or the like). As another example, noncompliance engine 156 may calculate the percentage of transactions (or percentage of money spent) having a certain noncompliance characteristic (e.g., 4 percent of transactions in the consumer's transaction history show a personal expense, or the like).

In various embodiments, a weight (similar to characteristic weights 220 in FIG. 2) may be assigned to each noncompliance characteristic (similar to step 508 for assigning weights to delinquent behavioral characteristics, described herein), such that when producing the noncompliance score 350, certain noncompliance characteristics 312-316 may influence the resulting noncompliance score 350 more than others. For example, one noncompliance characteristic may be a stronger indicator of noncompliance with a financial policy by a consumer, or a company may be more worried about one noncompliance characteristic more than another. Therefore, the company and/or noncompliance engine 156 may assign a higher weight to such an noncompliance characteristic. The company utilizing compliance system 150 may simply input each desired characteristic weight into noncompliance UI 300 next to the respective noncompliance characteristic, and noncompliance engine 156 will receive, implement, and display the same on noncompliance UI 300. Additionally, the noncompliance characteristic weights may be revised or updated at any time to reflect changed needs of a company (i.e., the user of compliance system 150).

In various embodiments, though there may be numerous noncompliance characteristics 312-316 which noncompliance engine 156 may analyze to determine noncompliance score 350 for a consumer, the user of noncompliance engine 156 may select which noncompliance characteristics 312-316 are to be taken into account in producing noncompliance score 350. To do so, the user may select or deselect noncompliance characteristics 312-316, for example, by selecting selectors 302. Noncompliance engine 156 may receive such selections, and only utilize the selected noncompliance characteristics in producing noncompliance score 350 for a consumer. In various embodiments, different noncompliance characteristics may be utilized to produce noncompliance scores for different consumers or groups of consumers.

In various embodiments, as part of producing noncompliance score 350 for a consumer, the weight assigned to each noncompliance characteristic may be applied to (e.g., multiplied with) the respective noncompliance characteristic value calculated for the each noncompliance characteristic (similar to step 510 involving delinquent behavioral characteristics, as described herein), producing a weighted noncompliance characteristic value for each noncompliance characteristic. The weighted noncompliance characteristic values produced may be presented to the user on noncompliance UI 300. Additionally, for each noncompliance characteristic, there may be a weighted noncompliance characteristic value threshold, to which noncompliance engine 156 may compare the respective weighted noncompliance characteristic value to determine if that weighted noncompliance characteristic value for that noncompliance characteristic indicates that the consumer is, or is at-risk of, noncompliant with a company's financial policies at least for that noncompliance characteristic. For example, if first noncompliance characteristic 312 produces a weighted noncompliance characteristic value of 12 (an arbitrarily chosen value for the sake of this example), but such a weighted noncompliance characteristic value is above (or below) a weighted noncompliance characteristic value threshold indicating the tolerable weighted noncompliance characteristic value of that noncompliance characteristic, noncompliance engine 156 (or the user of compliance system 150) may determine that that consumer is noncompliant, or is likely to be noncompliant in the future, with the company's financial or transactional policy. Therefore, any weighted noncompliance characteristic value for one or more noncompliance characteristics may be the noncompliance score desired by the user of compliance system 150. Similarly, any value for one or more noncompliance characteristics 312-316 may be noncompliance score 350, and compared with a value threshold to determine if a consumer is, or is at-risk of being, noncompliant.

In various embodiments, noncompliance score 350 may be determined from multiple noncompliance characteristics. Therefore, noncompliance engine 156 may combine (e.g., sum or multiple) the weighted noncompliance characteristic values of the noncompliance characteristics 312-316 (e.g., by summing or multiplying), which may produce a transaction-level noncompliance score (e.g., noncompliance score 350) (similar to step 512 for combining weighted values of delinquent behavioral characteristics, as described herein) for the consumer. In various embodiments, noncompliance engine 156 may compare the transaction-level noncompliance score to a transaction-level noncompliance score threshold to determine if the transaction-level noncompliance score is above (or below) the transaction-level noncompliance score threshold (similar to step 614, as described herein). If the transaction-level noncompliance score is above (or below) the transaction-level noncompliance score threshold, compliance system 150 and/or the user thereof may determine that the subject transaction associated with the analyzed transaction information is, or is at-risk of, being noncompliant the company's financial policies.

The steps described above (similar to steps 602-614 of method 600) may be repeated for any desired number of transactions. For example, transaction information associated with a second transaction may be analyzed to produce a second transaction-level noncompliance score. Subsequently, a consumer-level noncompliance score may be produced (step 616) by combining (e.g., summing or multiplying) the transaction-level noncompliance scores (e.g., the first and second transaction-level noncompliance scores). In various embodiments, the consumer-level noncompliance score may be produced by combining the weighted noncompliance characteristic values of the noncompliance characteristics 312-316 for all transactions analyzed by noncompliance engine 156. In various embodiments, the consumer-level noncompliance score may be produced by combining all of the respective noncompliance characteristic values from all of the transactions in a consumer's transaction history (i.e., combining all the noncompliance characteristic values associated with noncompliance characteristic 312 from all transactions, combining all the noncompliance characteristic values associated with second noncompliance characteristic 314 from all transactions, etc.), applying (e.g., multiplying by) the respective noncompliance characteristic weight to each total noncompliance characteristic value, and/or combining (e.g., summing or multiplying) the resulting weighted values. The company may have selected a consumer-level noncompliance score threshold, above (or below) which, the company has decided will indicate that the consumer is noncompliant. Therefore, noncompliance engine 156 or the user may compare the consumer-level noncompliance score with the consumer-level noncompliance threshold to determine whether the score is above (or below) the threshold (step 618). Based on that determination, noncompliance engine 156 or the user may determine if the subject consumer is compliant. Any of the (weighted) values described herein may be displayed on noncompliance UI 300.

In various embodiments, transaction-level noncompliance scores may be scaled to rank the associated transactions by level of (potential) noncompliance, and/or consumer-level noncompliance scores may be scaled to rank the associated consumers by level of (potential) noncompliance.

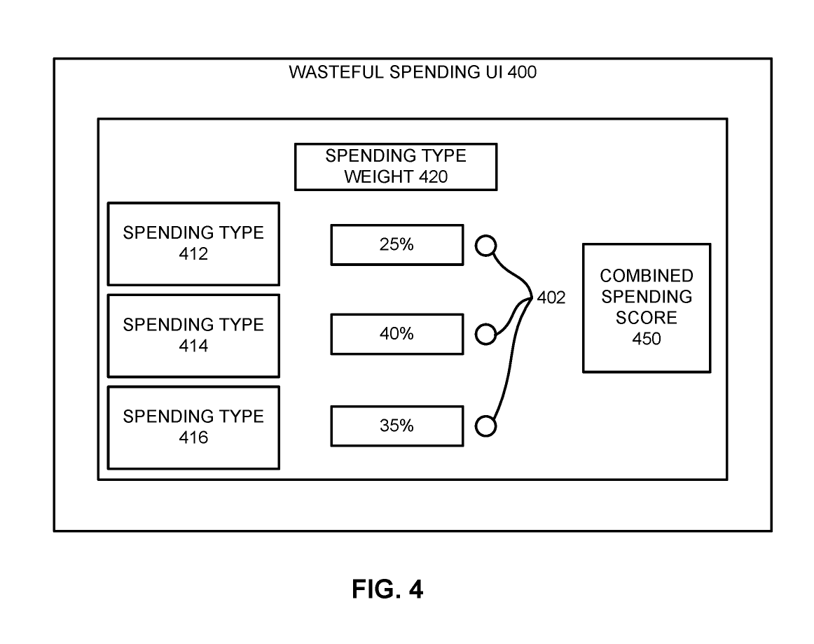

In various embodiments, with reference to FIGS. 1 and 4, wasteful spending engine 158 may detect if a consumer's transactions are wasteful (i.e., spending more money than is necessary, and/or conducting transactions against company policy causing financial waste). A company using compliance system 150 may have certain guidelines for transactions for which the company will pay, such as transactions related to travel. Therefore, wasteful spending engine 158 may be configured to monitor and/or evaluate transactions, such as travel expenses, to determine if a consumer (e.g., an employee of the company) is engaging in wasteful transactions (i.e., unnecessary transactions that are against company policy). Therefore, wasteful spending engine 158 may produce a spending type score for a consumer engaging in a certain type of spending, and/or a combined spending score, taking into account multiple spending types. The spending type score and/or combined spending score may be calculated on the transaction level or the consumer level, which may indicate whether the consumer's transactions are wasteful (i.e., if the consumer was transacting differently (having different parameters for a spending type, as discussed herein), the consumer would be saving some amount of company money). Therefore, the wastefulness, indicated in the spending type scores and/or combined spending scores produced by wasteful spending engine 158, reflects money that could be saved by different spending by the consumer. Wasteful spending UI 400 may be displayed to a user of system 100 and/or compliance system 150 via wasteful spending engine 158 and/or compliance system 150 on a display screen 122 comprised in web client 120.

In various embodiments, the company (or other user) using compliance system 150 may determine and input into compliance system 150 and/or wasteful spending engine 158 spending types (e.g., spending types 412-416) which the company would like to analyze. That is, the spending types may comprise types of transactions regarding which the company has rules, and therefore, may be able to detect wasteful financial behavior, for example, by failing to follow those rules. Therefore, the company may determine that it would like to analyze, and/or wasteful spending engine 158 may be capable of analyzing, transaction information for spending types 412-416.

In various embodiments, spending types 412-416 may comprise travel-related spending, such as on air travel, ground travel, lodging, and/or food and beverage. Each spending type may comprise one or more parameters which wasteful spending engine 158 may analyze and/or measure to determine the level of spending and/or waste. For example, for air travel, the parameters may include booking time (e.g., how far in advance the ticket was booked, for example, 7 days or 21 days), cost per mile (i.e., the average cost per mile for a consumer, which may include analyzing for upgrade fees, seat placement (coach versus business or first class), etc.), the airline used (a company may have approved or preferred airlines), or the like. For ground travel, the parameters may include cost per trip (e.g., per taxi ride, or the total ground travel expenses per business trip to another geographic location), average daily cost, travel company (a company may have approved or preferred ground travel company), or the like. For lodging, the parameters may include booking time, average rate (e.g., average daily rate, which may take into consideration ancillary fees), duration (e.g., number of days, or number of weekend days), lodging company, or the like. For food and beverage, the parameters may include an average daily spend, an average meal rate, an average meal type rate (e.g., an average for breakfast, lunch, and dinner, separately), or the like.

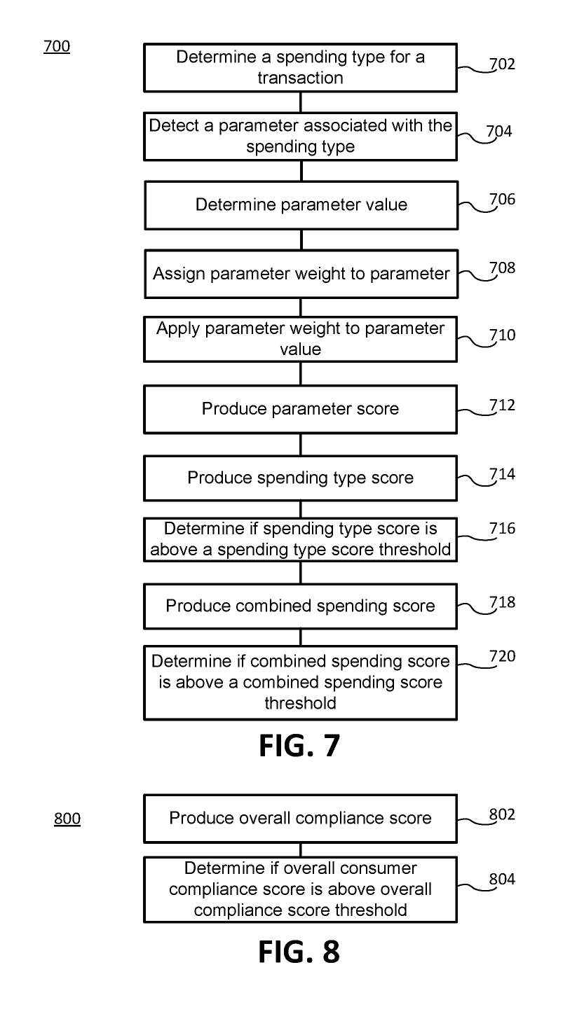

In various embodiments, with additional reference to FIG. 7, which depicts a method 700 for producing a spending score, wasteful spending engine 158 may determine a spending type score or a spending score for a transaction(s) and/or a consumer. By utilizing wasteful spending engine 158, a company may be able to determine employees with a history of making transactions with company funds that are wasteful, and reach out to the employee to reprimand or warn of such transactional behavior, or monitor the employees transactional behavior to stifle such waste. The user may indicate to wasteful spending engine 158 any time period during which transaction history may be evaluated to produce a spending score (e.g., by entering a start date and/or time and an end date and/or time). Also, wasteful spending engine 158 may offer reactive action, in which the company may analyze (e.g., in real time) a transaction as it is received by compliance system 150 and/or wasteful spending engine 158, and approve or deny the transaction or reimbursement request based on the spending (type) score from wasteful spending engine 158.

In various embodiments, compliance system 150 and/or wasteful spending engine 158 may receive transaction information associated with a consumer (e.g., transaction information for one or more transactions) from transaction database 140. As discussed above, the transaction information for a transaction may be received in real time. Wasteful spending engine 158 may analyze the transaction information for a transaction, and determine a spending type (i.e., a transaction type) (step 702) for the transaction (e.g., air travel, ground travel, lodging, and/or food and beverage). Wasteful spending engine 158 may analyze the transaction information for one or more of the parameters associated with the determined spending type, discussed above, in response to determining the spending type. For example, if wasteful spending engine 158 detects that a transaction is air travel, wasteful spending engine 158 may analyze the associated transaction information for booking time, cost per mile, airline, or the like. That is, wasteful spending engine 158 may detect a parameter in the transaction information associated with the spending type (step 704).

In response to detecting a parameter(s) associated with the spending type in the transaction information, (the transaction information for a transaction may comprise one or more parameters), wasteful spending engine 158 may determine a parameter value (step 706) associated with each parameter. Determining the parameter value may comprise detecting and/or calculating the amount of money spent for the parameter (e.g., determining the cost per mile), or another value (e.g., the amount ahead of time a ticket was booked for the booking time parameter, or the airline used). The parameter values produced may be presented to the user on a spending type UI (e.g., a UI similar to wasteful spending UI 400 for one or more spending types). Each parameter and/or parameter value may be displayed on the spending type UI similar to how spending types 412-416 are displayed on wasteful spending UI 400. Additionally, for each parameter, there may be a parameter value threshold, to which wasteful spending engine 158 may compare the respective parameter value to determine if that parameter value for that parameter indicates that the consumer is at-risk for, or committing, financial waste at least for that parameter. For example, if a first parameter value was for booking time, and the consumer booked 10 days before the flight, but company policy is booking at least 14 days before the flight (the parameter threshold), wasteful spending engine 158 (or the user of compliance system 150) may determine that that consumer is, or is at-risk of, be financially wasteful.

In various embodiments, a parameter weight may be assigned to each parameter (step 708), such that when producing the spending type score, certain parameters may influence the resulting risk score more than others. For example, one parameter may be a stronger indicator of wasteful spending by a consumer, or a company may be more worried about one parameter more than another. Therefore, the company and/or wasteful spending engine 158 may assign a higher weight to such a parameter. The spending type UI for each spending type, similar to wasteful spending UI 400, may be presented to the user of compliance system 150, showing each parameter and the weight associated with the respective parameter. The company utilizing compliance system 150 may simply input each desired parameter and respective parameter weight into a spending type UI next to the respective parameter, and wasteful spending engine 158 will receive, implement, and display the same on the spending type UI. Additionally, the parameter weights may be revised or updated at any time to reflect changed needs of a company (i.e., the user of compliance system 150).

In various embodiments, though there may be numerous parameters for each spending type, which wasteful spending engine 158 may detect and analyze to determine a spending type score for a transaction and/or consumer, the user of wasteful spending engine 158 may select which parameters are to be taken into account in producing the spending type score. To do so, the user may select or deselect the parameters, for example, by clicking on selectors, similar to selectors 402 for selecting spending types in producing a combined spending score 450 (in FIG. 4), as described herein. Wasteful spending engine 158 may receive such selections, and only utilize the selected parameters in producing the spending type score for a transaction and/or consumer. In various embodiments, different parameters may be utilized to produce spending type scores for different consumers or groups of consumers.

In various embodiments, each parameter may be customized to select the peer group for the subject consumer (so the parameter levels are measured against consumers of similar employee levels), geographic location (because some locations may be more expensive than others), time of year, or other variables so that any comparisons between a spending (type) score or a spending (type) threshold and an average score may be compared against an average score from comparable values or variables.

In various embodiments, as part of producing the spending type score for a transaction or a consumer, the weight assigned to each parameter may be applied to (e.g., multiplied by) the respective parameter value calculated for the each parameter (step 710), producing a parameter score (step 712) for each parameter. Wasteful spending engine 158 may produce a spending type score (step 714) by combining (e.g., summing or multiplying) the parameter scores for each parameter being taken into consideration for a spending type. The spending type score may be, or may represent, an average cost associated with the spending type for the analyzed transaction history (e.g., average cost per mile for air travel, average daily rate for lodging, average daily spend for food and beverage, and/or average daily cost for ground transportation). The spending type score produced for a transaction or consumer may be presented to the user on the spending type UI (similar to the display of combined spending score 450 on wasteful spending UI 400). Additionally, for each spending type, there may be a spending type score threshold (e.g., an average cost associated with the respective spending type, which the company may find reasonable or compliant), to which wasteful spending engine 158 may compare the respective spending type score to determine if that spending type score for that spending type is above (or below) the spending type score threshold (step 716) (which may indicate that the consumer is at-risk for, or committing, financial waste at least for that spending type). For example, if a first spending type was for air travel, and the consumer's first spending type score was the product of a cost per mile higher than average (the average reflected in a spending type score threshold lower than the first spending type score), wasteful spending engine 158 (or the user of compliance system 150) may determine that that consumer is, or is at-risk of, be financially wasteful.

In various embodiments, wasteful spending engine 158 may produce a combined spending score 450 (step 718) by applying spending type weights 420 (selected by the user to reflect the relative importance of each spending type in determining waste) to the spending type scores and combining (e.g., summing or multiplying) the resulting weighted spending type scores. The user may select which spending types 412-416 to take into consideration in producing combined spending score 450 by selecting selectors 402. The combined spending score 450 produced for a transaction or consumer may be presented to the user on the wasteful spending UI 400. Additionally, there may be a combined spending score threshold, to which wasteful spending engine 158 may compare combined spending score 450 to determine if that combined spending score 450 for a consumer or transaction is above (or below) the combined spending score threshold (step 720) (which may indicate that the consumer is at-risk for, or committing, financial waste).

In various embodiments, spending type scores may be scaled to rank the associated transactions by level of (potential) financial waste, and/or combined spending scores may be scaled to rank the associated consumers by level of (potential) financial waste.

The analysis or production of scores produced by compliance system 150 may be customized to select the peer group for the subject consumer (so the parameter levels are measured against consumers of similar employee levels), geographic location (because some locations may be more expensive than others), time of year, or other variables so that a compliance score produced for a consumer or transaction may be compared against a score threshold determined based on comparable values or variables.

In various embodiments, with reference to FIGS. 1 and 8, the compliance scores from payment risk engine 152 (delinquent risk score 250), noncompliance engine 156 (consumer-level and/or transaction-level noncompliance score 350), and/or wasteful spending engine 158 (combined spending score 450) may be used in method 800 to produce an overall compliance score (step 802) from compliance system 150. In various embodiments, a compliance score weight may be assigned to each compliance score produced by compliance system 150, such that when producing the overall compliance score, compliance scores from certain engines 152-158 may influence the resulting overall compliance score more than others. For example, one compliance score may be a stronger indicator of compliance with a company policy by a consumer, or a company may be more worried about one compliance score more than another. Therefore, the company and/or compliance system 150 may assign a higher weight to such a compliance score. A UI for the compliance system 150, similar to UIs 200-400, may be presented to the user of compliance system 150, showing each compliance score produced by engines 152-158 and/or each compliance score weight. The company utilizing compliance system 150 may simply input each desired compliance score weight into the compliance system UI next to the respective compliance score, and compliance system 150 will receive, implement, and display the same on the compliance system UI. Additionally, the compliance score weights may be revised or updated at any time to reflect changed needs of a company (i.e., the user of compliance system 150).

In various embodiments, though there may be multiple compliance scores (e.g., one from each engine 152-158), the user of compliance system 150 may select which compliance scores are to be taken into account in producing the overall compliance score. To do so, the user may select or deselect the compliance scores, for example, by clicking on selectors, similar to selectors 402. Compliance System 150 may receive such selections, and only utilize the selected compliance scores in producing the overall compliance score for a transaction and/or consumer. In various embodiments, different compliance scores may be utilized to produce overall compliance scores for different consumers or groups of consumers.

In various embodiments, as part of producing the overall compliance score for a transaction or a consumer, the compliance score weight assigned to each compliance score may be applied to the compliance score calculated by each engine 152-158, producing weighted compliance scores for each engine 152-158. Compliance system 150 may produce the overall compliance score (step 802) by combining (e.g., summing or multiplying) the weighted compliance scores for each compliance score being taken into consideration. The overall compliance score produced for a transaction or consumer may be presented to the user on the compliance system UI (similar to the display of combined spending score 450 on wasteful spending UI 400). Additionally, there may be an overall compliance score threshold, to which compliance system 150 may compare the overall compliance score to determine if that overall compliance score for a consumer or transaction is above (or below) the overall compliance score threshold (step 804) (which may indicate that the consumer is, or is at-risk for being, noncompliant with company policy).

The systems and methods discussed herein improve the functioning of the computer. For example, by utilizing compliance system 150 including any of the engines 152-158 comprise therein, the accuracy of compliance scoring and determination increases. A user of system 100 and/or compliance system 150 may select which variables, transaction information, and metrics may be most useful in evaluating the compliance with company policy of an employee or consumer, and therefore, customize the analysis and results to company needs.

The disclosure and claims do not describe only a particular outcome of determining financial policy compliance, but the disclosure and claims include specific rules for implementing the outcome of determining financial policy compliance and that render information into a specific format that is then used and applied to create the desired results of determining financial policy compliance, as set forth in McRO, Inc. v. Bandai Namco Games America Inc. (Fed. Cir. case number 15-1080, Sep. 13, 2016). In other words, the outcome of determining financial policy compliance can be performed by many different types of rules and combinations of rules, and this disclosure includes various embodiments with specific rules. While the absence of complete preemption may not guarantee that a claim is eligible, the disclosure does not sufficiently preempt the field of determining financial policy compliance at all. The disclosure acts to narrow, confine, and otherwise tie down the disclosure so as not to cover the general abstract idea of just determining financial policy compliance. Significantly, other systems and methods exist for determining financial policy compliance, so it would be inappropriate to assert that the claimed invention preempts the field or monopolizes the basic tools of determining financial policy compliance. In other words, the disclosure will not prevent others from determining financial policy compliance, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber (e.g., a user, consumer, etc.) when their computer is offline. The system may include generating customized information and alerting a remote subscriber that the transaction and/or identifier information can be accessed from their computer. The alerts are generated by filtering received information, building information alerts and formatting the alerts into data blocks based upon subscriber preference information. The data blocks are transmitted to the subscriber's web client 120 which, when connected to a computer, causes the computer to auto-launch an application to display the information alert and provide access to more detailed information about the information alert. More particularly, the method may comprise providing a viewer application to a subscriber for installation on a remote subscriber computer and/or web client 120; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generating an information alert from the filtered information that contains a name, a price and a universal resource locator (URL), which specifies the location of the data source; formatting the information alert into data blocks according to said information format; and transmitting the formatted information alert over a wireless communication channel to web client 120 associated with the consumer based upon the destination address and transmission schedule, wherein the alert activates the application to cause the information alert to display on the remote subscriber computer and/or web client 120 and to enable connection via the URL to the data source over the Internet when web client 120 is locally connected to the remote subscriber computer and the remote subscriber computer comes online.

In various embodiments, the system and method may include a graphical user interface (i.e., comprised in web client 120) for dynamically relocating/rescaling obscured textual information of an underlying window to become automatically viewable to the user. Such textual information may be comprised in compliance system 150 and/or any other interface presented to the consumer or user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen (comprised in web client 120, for example); displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., email, messages within merchant system 130 and/or compliance system 150) to prevent a computer, server, and/or system from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which thus forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over consumers during affiliate purchase transactions, using a system for co-marketing the “look and feel” of the host web page (e.g., a web page from merchant system 130) with the product-related content information of the advertising merchant's web page. The system can be operated by a third-party outsource provider, who acts as a broker between multiple hosts and merchants. Prior to implementation, a host places links to a merchant's server on the host's web page (e.g., a web page from merchant system 130). The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A consumer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the consumer as associated with the host web page. The server then transmits and presents this composite web page to the consumer so that she effectively remains on the host web page to purchase the item without being redirected to the third party merchant affiliate. Because such composite pages are visually perceived by the consumer as associated with the host web page, they give the consumer the impression that she is viewing pages served by the host. Further, the consumer is able to purchase the item without being redirected to the third party merchant affiliate, thus allowing the host to retain control over the consumer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a consumer, (ii) transaction information, and/or (iii) a compliance score. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

The system or any components may integrate with system integration technology such as, for example, the ALEXA system developed by AMAZON. Alexa is a cloud-based voice service that can help you with tasks, entertainment, general information and more. All Amazon Alexa devices, such as the Amazon Echo, Amazon Dot, Amazon Tap and Amazon Fire TV, have access to the Alexa Voice Service. The system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The system may allow the user to access information about eligible accounts linked to an online account across all Alexa-enabled devices.

The phrases consumer, customer, user, account holder, account affiliate, cardmember or the like shall include any person, entity, business, government organization, business, software, hardware, machine associated with a transaction account, who buys merchant offerings offered by one or more merchants using the account and/or who is legally designated for performing transactions on the account, regardless of whether a physical card is associated with the account. For example, the cardmember may include a transaction account owner, a transaction account user, an account affiliate, a child account user, a subsidiary account user, a beneficiary of an account, a custodian of an account, and/or any other person or entity affiliated or associated with a transaction account.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A record of charge (or “ROC”) may comprise any transaction or transaction information/details. The ROC may be a unique identifier associated with a transaction. Record of Charge (ROC) data includes important information and enhanced data. For example, a ROC may contain details such as location, merchant name or identifier, transaction amount, transaction date, account number, account security pin or code, account expiry date, and the like for the transaction. Such enhanced data increases the accuracy of matching the transaction data to the receipt data. Such enhanced ROC data is NOT equivalent to transaction entries from a banking statement or transaction account statement, which is very limited to basic data about a transaction. Furthermore, a ROC is provided by a different source, namely the ROC is provided by the merchant to the transaction processor. In that regard, the ROC is a unique identifier associated with a particular transaction. A ROC is often associated with a Summary of Charges (SOC). The ROCs and SOCs include information provided by the merchant to the transaction processor, and the ROCs and SOCs are used in the settlement process with the merchant. A transaction may, in various embodiments, be performed by a one or more members using a transaction account, such as a transaction account associated with a gift card, a debit card, a credit card, and the like.

Distributed computing cluster may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In various embodiments, the server may include application servers (e.g. WEB SPHERE, WEB LOGIC, JBOSS, EDB® Postgres Plus Advanced Server® (PPAS), etc.). In various embodiments, the server may include web servers (e.g. APACHE, IIS, GWS, SUN JAVA® SYSTEM WEB SERVER, JAVA Virtual Machine running on LINUX or WINDOWS).

Practitioners will appreciate that web client 120 may or may not be in direct contact with an application server. For example, web client 120 may access the services of an application server through another server and/or hardware component, which may have a direct or indirect connection to an Internet server. For example, web client 120 may communicate with an application server via a load balancer. In various embodiments, access is through a network or the Internet through a commercially-available web-browser software package.

As those skilled in the art will appreciate, web client 120 may include an operating system (e.g., WINDOWS®/CE/Mobile, OS2, UNIX®, LINUX®, SOLARIS®, MacOS, etc.) as well as various conventional support software and drivers typically associated with computers. Web client 120 may include any suitable personal computer, network computer, workstation, personal digital assistant, cellular phone, smart phone, minicomputer, mainframe or the like. Web client 120 can be in a home or business environment with access to a network. In various embodiments, access is through a network or the Internet through a commercially available web-browser software package. Web client 120 may implement security protocols such as Secure Sockets Layer (SSL) and Transport Layer Security (TLS). Web client 120 may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” may include any good, service, information, experience, entertainment, data, offer, discount, rebate, points, virtual currency, content, access, rental, lease, contribution, account, credit, debit, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, blockchain, object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), MongoDB®, Redis®, Apache Cassandra®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of web client 120 may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js® programs. Node.js® may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As used herein, the term “end user,” “consumer,” “customer,” “cardmember,” “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express®, VisaNet®, Veriphone®, Discover Card®, PayPal®, ApplePay®, GooglePay®, private networks (e.g., department store networks), and/or any other payment networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to a “party” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account,” “account number,” “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000.” The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “transaction account,” “financial transaction instrument,” “transaction instrument” and/or the plural form of these terms may be used interchangeably throughout to refer to a financial instrument. Phrases and terms similar to “transaction account” may include any account that may be used to facilitate a financial transaction.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a processor, a transaction history for a consumer having transaction information associated with a plurality of transactions;
detecting, by the processor, within the transaction information for each transaction of the plurality of transactions a characteristic, resulting in a plurality of characteristics;
calculating, by the processor, a value associated with each characteristic of the plurality of characteristics, wherein the respective value is at least one of a number or percentage of transactions having the characteristic;
assigning, by the processor, a respective weight to each characteristic of the plurality of characteristics, producing an assigned respective weight for each characteristic;
applying, by the processor, the assigned respective weight to the respective value associated with each characteristic to produce a respective weighted value for each characteristic of the plurality of characteristics;
combining, by the processor, the respective weighted values of the plurality of characteristics; and
producing, by the processor, a compliance score in response to the combining the respective weighted values.

2. The method of claim 1, further comprising determining, by the processor, whether the compliance score is above a compliance score threshold.

3. The method of claim 1, wherein the characteristic is a delinquent behavioral characteristic, which is at least one of a returned check, a late payment charge, or a late credit payment, and wherein the compliance score is a delinquent risk score.

4. The method of claim 1, wherein the characteristic is a noncompliance characteristic, which is at least one of a transaction from an unauthorized or suspicious merchant, for a personal expense, in a disallowed geographic location, during late-night hours, for a retail purchase, involving a cash withdrawal, or involving an expensed refund,
wherein the value is a noncompliance characteristic value,
wherein the weighted value is a noncompliance characteristic weighted value, and
wherein the compliance score is a consumer-level noncompliance score,
wherein the method further comprises:
combining, by the processor, the respective noncompliance characteristic weighted values associated with a single transaction of the plurality of transactions; and
producing, by the processor, a transaction-level noncompliance score in response to the combining the noncompliance characteristic weighted values associated with a single transaction of the plurality of transactions.

5. The method of claim 4, further comprising at least one of:
determining, by the processor, whether the consumer-level noncompliance score is above a consumer-level noncompliance score threshold; or
determining, by the processor, whether the transaction-level noncompliance score is above a transaction-level noncompliance score threshold.

6. The method of claim 1, further comprising:
analyzing, by the processor, transaction information associated with a first transaction of the plurality of transactions for a critical noncompliance characteristic and a peripheral noncompliance characteristic;
detecting, by the processor, at least one of the critical noncompliance characteristic or the peripheral noncompliance characteristic in the transaction information associated with the first transaction;
flagging, by the processor, the first transaction with at least one of a critical flag in response to detecting a critical noncompliance characteristic, or a peripheral flag in response to detecting a peripheral noncompliance characteristic;
calculating, by the processor, at least one of a critical characteristic value associated with the at least one critical noncompliance characteristic or a peripheral characteristic value associated with the at least one peripheral noncompliance characteristic;
assigning, by the processor, a critical weight to the critical noncompliance characteristic and a peripheral weight to the peripheral noncompliance characteristic;
applying, by the processor, at least one of the critical weight to the critical characteristic value, or the peripheral weight to the peripheral characteristic value;
producing, by the processor, a first transaction-level noncompliance score in response to the applying at least one of the critical weight to the critical characteristic value, or the peripheral weight to the peripheral characteristic value; and
determining, by the processor, whether the transaction-level noncompliance score is above a transaction-level noncompliance score threshold.

7. The method of claim 6, further comprising:
analyzing, by the processor, second transaction information associated with a second transaction of the plurality of transactions for a second critical noncompliance characteristic and a second peripheral noncompliance characteristic;
detecting, by the processor, at least one of the second critical noncompliance characteristic or the second peripheral noncompliance characteristic in the second transaction information associated with the second transaction;
flagging, by the processor, the second transaction with at least one of a second critical flag in response to detecting the second critical noncompliance characteristic, or a second peripheral flag in response to detecting the second peripheral noncompliance characteristic;
calculating, by the processor, at least one of a second critical characteristic value associated with the second critical noncompliance characteristic or a second peripheral characteristic value associated with the second peripheral noncompliance characteristic;
applying, by the processor, at least one of the critical weight to the second critical noncompliance characteristic, or the peripheral weight to the second peripheral noncompliance characteristic;
producing, by the processor, a second transaction-level noncompliance score in response to the applying at least one of the critical weight to the second critical noncompliance characteristic, or the peripheral weight to the second peripheral noncompliance characteristic; and
determining, by the processor, whether the second transaction-level noncompliance score is above the transaction-level noncompliance score threshold.

8. The method of claim 7, further comprising combining, by the processor, the first transaction-level noncompliance score and the second transaction-level noncompliance score to produce a consumer-level noncompliance score; and determining, by the processor, whether the consumer-level noncompliance score is above a consumer-level noncompliance score threshold.

9. The method of claim 8, further comprising combining, by the processor, the consumer-level noncompliance score and the compliance score to produce an overall consumer compliance score; and determining, by the processor, whether the overall consumer compliance score is above an overall consumer score threshold.

10. The method of claim 1, further comprising:
determining, by the processor, a first spending type of a first transaction of the plurality of transactions;
detecting, by the processor, a parameter associated with the first spending type in the transaction information of the first transaction;
determining, by the processor, a parameter value of the parameter;
assigning, by the processor, a parameter weight to the parameter;
applying, by the processor, the parameter weight to the parameter value;
producing, by the processor, a parameter score based on the applying the parameter weight to the parameter value;
producing, by the processor, a spending score based on the parameter score; and
determining, by the processor, if the spending score is above a spending score threshold.

11. The method of claim 10, wherein the spending type is at least one of air travel and the parameter is at least one of booking time, cost per mile, or airline; ground travel and the parameter is at least one of booking time, cost per trip, or travel company; hotel and the parameter is at least one of booking time, average rate, and duration; or food and beverage and the parameter is at least one of average daily spend or average meal rate.

12. An article of manufacture including a non-transitory, tangible computer readable memory having instructions stored thereon that, in response to execution by a processor, cause the processor to perform operations comprising:
receiving, by the processor, a transaction history for a consumer having transaction information associated with a plurality of transactions;
detecting, by the processor, within the transaction information for each transaction of the plurality of transactions a characteristic, resulting in a plurality of characteristics;
calculating, by the processor, a value associated with each characteristic of the plurality of characteristics, wherein the respective value is at least one of a number or percentage of transactions having the characteristic;
assigning, by the processor, a respective weight to each characteristic of the plurality of characteristics, producing an assigned respective weight for each characteristic;
applying, by the processor, the assigned respective weight to the respective value associated with each characteristic to produce a respective weighted value for each characteristic of the plurality of characteristics;
combining, by the processor, the respective weighted values of the plurality of characteristics; and
producing, by the processor, a compliance score in response to the combining the respective weighted values.

13. The article of claim 12, wherein the characteristic is a delinquent behavioral characteristic, which is at least one of a returned check, a late payment charge, or a late credit payment, and wherein the compliance score is a delinquent risk score.

14. The article of claim 12, wherein the characteristic is a noncompliance characteristic, which is at least one of a transaction from an unauthorized or suspicious merchant, for a personal expense, in a disallowed geographic location, during late-night hours, for a retail purchase, involving a cash withdrawal, or involving an expensed refund,
wherein the value is a noncompliance characteristic value,
wherein the weighted value is a noncompliance characteristic weighted value, and
wherein the compliance score is a consumer-level noncompliance score,
wherein the operations further comprise:
combining, by the processor, the respective noncompliance characteristic weighted values associated with a single transaction of the plurality of transactions; and
producing, by the processor, a transaction-level noncompliance score in response to the combining the noncompliance characteristic weighted values associated with a single transaction of the plurality of transactions.

15. The article of claim 12, wherein the operations further comprise:
analyzing, by the processor, transaction information associated with a first transaction of the plurality of transactions for a critical noncompliance characteristic and a peripheral noncompliance characteristic;
detecting, by the processor, at least one of the critical noncompliance characteristic or the peripheral noncompliance characteristic in the transaction information associated with the first transaction;
flagging, by the processor, the first transaction with at least one of a critical flag in response to detecting a critical noncompliance characteristic, or a peripheral flag in response to detecting a peripheral noncompliance characteristic;
calculating, by the processor, at least one of a critical characteristic value associated with the at least one critical noncompliance characteristic or a peripheral characteristic value associated with the at least one peripheral noncompliance characteristic;
assigning, by the processor, a critical weight to the critical noncompliance characteristic and a peripheral weight to the peripheral noncompliance characteristic;
applying, by the processor, at least one of the critical weight to the critical characteristic value, or the peripheral weight to the peripheral characteristic value;
producing, by the processor, a first transaction-level noncompliance score in response to the applying at least one of the critical weight to the critical characteristic value, or the peripheral weight to the peripheral characteristic value; and
determining, by the processor, whether the transaction-level noncompliance score is above a transaction-level noncompliance score threshold.

16. The article of claim 12, wherein the operations further comprise:
determining, by the processor, a first spending type of a first transaction of the plurality of transactions;
detecting, by the processor, a parameter associated with the first spending type in the transaction information of the first transaction;
determining, by the processor, a parameter value of the parameter;
assigning, by the processor, a parameter weight to the parameter;
applying, by the processor, the parameter weight to the parameter value;
producing, by the processor, a parameter score based on the applying the parameter weight to the parameter value; and
producing, by the processor, a spending score based on the parameter score;
determining, by the processor, if the spending score is above a spending score threshold.

17. A system comprising:
a processor; and
a tangible, non-transitory memory configured to communicate with the processor, the tangible, non-transitory memory having instructions stored thereon that, in response to execution by the processor, cause the processor to perform operations comprising:
receiving, by the processor, a transaction history for a consumer having transaction information associated with a plurality of transactions;
detecting, by the processor, within the transaction information for each transaction of the plurality of transactions a characteristic, resulting in a plurality of characteristics;
calculating, by the processor, a value associated with each characteristic of the plurality of characteristics, wherein the respective value is at least one of a number or percentage of transactions having the characteristic;
assigning, by the processor, a respective weight to each characteristic of the plurality of characteristics, producing an assigned respective weight for each characteristic;
applying, by the processor, the assigned respective weight to the respective value associated with each characteristic to produce a respective weighted value for each characteristic of the plurality of characteristics;
combining, by the processor, the respective weighted values of the plurality of characteristics; and
producing, by the processor, a compliance score in response to the combining the respective weighted values.

18. The system of claim 17, wherein the characteristic is a noncompliance characteristic, which is at least one of a transaction from an unauthorized or suspicious merchant, for a personal expense, in a disallowed geographic location, during late-night hours, for a retail purchase, involving a cash withdrawal, or involving an expensed refund,
wherein the value is a noncompliance characteristic value,
wherein the weighted value is a noncompliance characteristic weighted value, and
wherein the compliance score is a consumer-level noncompliance score,
wherein the operations further comprise:
combining, by the processor, the respective noncompliance characteristic weighted values associated with a single transaction of the plurality of transactions; and
producing, by the processor, a transaction-level noncompliance score in response to the combining the noncompliance characteristic weighted values associated with a single transaction of the plurality of transactions.

19. The system of claim 17, wherein the operations further comprise:
analyzing, by the processor, transaction information associated with a first transaction of the plurality of transactions for a critical noncompliance characteristic and a peripheral noncompliance characteristic;
detecting, by the processor, at least one of the critical noncompliance characteristic or the peripheral noncompliance characteristic in the transaction information associated with the first transaction;
flagging, by the processor, the first transaction with at least one of a critical flag in response to detecting a critical noncompliance characteristic, or a peripheral flag in response to detecting a peripheral noncompliance characteristic;
calculating, by the processor, at least one of a critical characteristic value associated with the at least one critical noncompliance characteristic or a peripheral characteristic value associated with the at least one peripheral noncompliance characteristic;
assigning, by the processor, a critical weight to the critical noncompliance characteristic and a peripheral weight to the peripheral noncompliance characteristic;
applying, by the processor, at least one of the critical weight to the critical characteristic value, or the peripheral weight to the peripheral characteristic value;
producing, by the processor, a first transaction-level noncompliance score in response to the applying at least one of the critical weight to the critical characteristic value, or the peripheral weight to the peripheral characteristic value; and
determining, by the processor, whether the transaction-level noncompliance score is above a transaction-level noncompliance score threshold.

20. The system of claim 17, wherein the operations further comprise:
determining, by the processor, a first spending type of a first transaction of the plurality of transactions;
detecting, by the processor, a parameter associated with the first spending type in the transaction information of the first transaction;
determining, by the processor, a parameter value of the parameter;
assigning, by the processor, a parameter weight to the parameter;
applying, by the processor, the parameter weight to the parameter value;
producing, by the processor, a parameter score based on the applying the parameter weight to the parameter value; and
producing, by the processor, a spending score based on the parameter score;
determining, by the processor, if the spending score is above a spending score threshold.
